(19) United States
(12) Patent Application Publication
(10) Pub. No.: US 2025/0044835 A1
(43) Pub. Date: Feb. 6, 2025

(54) NECK MOUNTED COMPUTING DEVICE AND SYSTEM

(71) Applicant: SINA HAFEZI, Reston, VA (US)

(72) Inventor: SINA HAFEZI, Reston, VA (US)

(21) Appl. No.: 18/782,859

(22) Filed: Jul. 24, 2024

(30) Foreign Application Priority Data
Aug. 4, 2023 (GB) 2311982.9

(51) Int. Cl. G06F 1/16

(52) U.S. Cl. CPC G06F 1/163

(57) ABSTRACT

A computing device for mounting on a neck of a user, and a system comprising the computing device and a separate head mounted device. The computing device has a housing, one or more processors, one or more memories, and wherein the housing is configured to mount to the back of the user's neck and is shaped to occupy a volume that extends from the back of the user's neck away from the user's neck but that does not extend substantially around the sides of the user's neck. In use the computing device is in communication with a head mounted device.

### TECHNICAL FIELD

The present invention relates to a computing device for mounting on a neck of a user, and a system comprising the computing device and a head mounted device.

### BACKGROUND

Head mounted devices, such as augmented reality headsets, typically have a computing system embedded within the head mounted device itself. The computing system embedded in the device comprises the processors, batteries and sensors required for the head mounted device to operate. Such head mounted devices have a limited battery life and processing power as the computing system is limited to being light and small enough to be comfortably worn on a user's head.

Other known head mounted devices address this problem by being connected to a U-shaped neck piece, where this neck piece has batteries, sensors, or processors spread throughout a U-shaped neck piece which sits around the neck, spreading the weight onto the shoulders. However, such devices are very large, making it difficult to transport the device when not being worn. As these devices are large, they are very visible as they nearly completely surround the neck. Their size also limits movement of the user, and are cumbersome to wear. As the batteries, sensors and processors are essential to the functioning of the head mounted device, and the neckpiece and head mounted device are connected to each other, the neckpiece must be worn each time the user wears the head mounted device. The U-shaped geometry also limits the design of the motherboard, and the use of electronic components with standard dimensions throughout the device. This is because such a U-shaped neckpiece is limited to having a narrow width and diameter, to enable it to be worn without being in the way of the user.

It would be desirable to provide a computing device for mounting on the neck of a user which has a reduced size, and can be mounted to the user in a variety of ways.

### SUMMARY OF THE INVENTION

The invention is defined in the independent claims to which reference should now be made. Advantageous features are set out in the dependent claims.

In a first aspect of the invention there is provided a computing device for mounting on a neck of a user, the device comprising a housing, one or more processors mounted within the housing and configured to process data received from a head mounted device, and one or more memories mounted within the housing and coupled to the one or more processors. The housing is configured to mount to the back of the user's neck and is shaped to occupy a volume that extends from the back of the user's neck away from the user's neck but that does not extend substantially around the sides of the user's neck.

This first aspect has the advantage of providing a housing which processes data received from a head mounted device. Therefore, the head mounted device itself does not need to comprise processors or other computing components, which improves available processing power as there is more space in the neck mounted computing device for processors and other computing than in a head mounted device. The size and shape of the computing device, and it being mounted on a user's neck, does not impact freedom of movement of the user when the computing device is being used.

Optionally the computing device comprises a connector attached to the housing, wherein the connector is configured to connect the housing to a mounting element and wherein the mounting element is configured to releasably mount the device on a wearable unit. This has the advantage that the computing device can be releasably mounted onto a wearable unit, so that it can be worn, removed and reused.

Optionally the computing device further comprises the mounting element, the computing device further comprising a guide mechanism for guiding the connector into a corresponding portion of the mounting element which is shaped to receive the connector, such that the user can mount the computing device to the mounting element in use. This has the advantage that the user can easily mount the computing device to the mounting element, and therefore on the wearable unit when the wearable unit is already being worn. Optionally the guide mechanism comprises one or more channels configured to receive corresponding rail portions, wherein the connector is connected to the mounting element by a sliding motion. This has the advantage that the connector can be easily slid into the mounting element, as the channels and rail portions help guide the connector into the mounting element. Further optionally, the one or more channels are provided on the mounting element and the rail portions are provided on the connector or vice versa.

Optionally the connector is a hook, and the mounting element is configured to receive the hook. The hook may optionally be shaped to be received in the mounting element and the hook is supported away from the housing via a leg, wherein the leg has a smaller cross sectional area than the hook area.

Optionally a motherboard is mounted to the housing, and wherein the one or more processors, and the one or more memories are mounted to the motherboard. The housing may be internally shaped to correspond to the shape of the motherboard. This has the advantage that the size of the computing device is as small as possible, whilst also accommodating the motherboard.

Optionally the housing is a rectangular box. This has the advantage that standard motherboards will fit in it, and will enable a larger processor to be mounted within the computing device due to the box's width compared to processors mounted within a head mounted device.

Optionally the computing device further comprises a power source mounted within the housing. This has the advantage that the computing device can be used to power the head mounted device without requiring a power source within the head mounted device.

Optionally the computing device further comprises a power source located remotely from the computing device. This has the advantage that no power source is required to be in the head mounted device or in the computing device.

Optionally the housing comprises a data line port on a face which faces towards the top of the user's head in use. This has the advantage that the data line port is as close to the head mounted device as possible, and any wire or cable connecting the head mounted device with the data line port can be as short as possible and will not get in the way of the user when in use.

Optionally the wearable unit is a neckband, and the mounting element comprises a hole or loop for the neckband to pass through such that the housing and mounting element are configured to be detachably mounted on a neckband. This has the advantage that the computing device can be easily mounted onto a neckband, and can be removed after use. As the mounting element comprises the hole or loop instead of the computing device itself, this enables the computing device to have a connector which is able to be connected to different wearable units via a mounting element.

Optionally the wearable unit is a self-adhesive patch for attaching to the skin, and the self-adhesive patch is attached to the mounting element, such that the device can be mounted on the skin. This has the advantage that the computing device can be even less visible when being worn, and can improve freedom of movement. Optionally the self-adhesive patch is flexible. This has the advantage that the comfort of the self adhesive patch is further improved. Optionally the self-adhesive patch has a greater area than the connector.

In a second aspect, there is provided a system comprising the computing device according to the first aspect, and a head mounted device, wherein the computing device and head mounted device are physically separate, and are electrically connected to each other.

As the computing device and head mounted device are physically separate, the weight or size of the computing device does not affect the comfort or usability of the head mounted device.

Optionally the head mounted device comprises one or more sensors for sensing environmental and/or user data.

Optionally each of the one or more sensors may be any of microphones, cameras, radar sensors, LiDAR, gyroscopes, accelerometers, button sensors and/or touch sensors.

Optionally the head mounted device comprises one or more output units for providing data to the user, and optionally to the surroundings. Each of the one or more output units may optionally be any of: one or more normal or transparent display screens, one or more directional air-conduction or bone-conduction speakers, one or more LEDs, one or more light projectors and/or one or more laser projectors.

Optionally the computing device and head mounted device are connected by one or more wires.

Optionally the computing device and head mounted device are connected by two wires, wherein one wire is connected to the computing device and one side of the head mounted device, and one wire is connected to the computing device and the other side of the head mounted device.

Optionally the one or more wires pass from the computing device to the head mounted device via the back of the user's head. This has the advantage that the wires have minimal interference with the user's movements or actions when the system is being worn.

Optionally the computing device may have a width of up to 120 mm, the width being the dimension of the computing device extending across the user's neck in use.

Optionally the computing device may have a height of up to 80 mm, the height being the dimension of the computing device extending up the user's neck from the base towards the head when in use.

Optionally the computing device may have a depth of up to 50 mm, the depth being the dimension of the computing device extending from the neck surface away from the user. Further optionally the computing device may have a depth of up to 20 mm.

Optionally the system comprises one or more strain relief mechanisms on the one or more wires. Optionally the system comprises two wires and wherein a strain relief mechanism is located at the interface between the one or more wires and the head mounted device, and wherein a strain relief mechanism is located between the head mounted device and the computing device. This has the advantage that the head mounted device can be removed from the head, and hung around the user's neck when not in use.

Optionally the head mounted device is any of an augmented reality headset, virtual reality headset, mixed reality headset, smart glasses, augment reality glasses, hearing aids, audio glasses, or hearing aid glasses.

### BRIEF DESCRIPTION OF THE DRAWINGS

Embodiments of the invention will now be described, by way of example only, and with reference to the accompanying drawings in which:

FIG. 1A illustrates a perspective view of a computing device;

FIG. 1B illustrates a first side view of the computing device;

FIG. 1C illustrates a second side view of the computing device;

FIG. 2A illustrates a front view of a computing device, showing the internal components;

FIG. 2B illustrates a back view respectively of the external ports of a computing device;

FIG. 3 illustrates an example of a mounting element;

FIG. 4A illustrates a top view of the mounting element mounted on a neck band;

FIG. 4B illustrates a bottom view of the mounting element mounted on a neck band;

FIG. 4C illustrates a side view of the mounting element mounted on a neck band;

FIG. 5 illustrates a top view of a mounting element mounted on an adhesive patch;

FIG. 6A illustrates the mounting element mounted on a neckband being worn by a user;

FIG. 6B illustrates the computing device being mounted on the neckband via the mounting element, and being worn by a user;

FIG. 7A illustrates the mounting element mounted on an adhesive patch being worn by a user;

FIG. 7B illustrates the computing device being mounted on the adhesive patch via the mounting element, and being worn by a user;

FIG. 8A illustrates a system being mounted on a user according to one embodiment;

FIG. 8B illustrates a system being mounted on a user according to another embodiment.

### DETAILED DESCRIPTION OF EXAMPLE EMBODIMENTS

The present invention relates to a computing device configured for mounting on a neck of a user. Having a separate computing device connected to a head mounted device, wherein the computing device comprises one or more processors and one or more memories, provides a more comfortable use of the head mounted device, whilst also improving processing power. Having a computing device which is compact and does not extend substantially around the user's neck, provides a less visible and more discreet computing device. This also provides more freedom of movement to a user wearing the device, as well as improving the ease of carrying the computing device. Embodiments of a computing device will be described herein which enable a computing device to be mounted on a neck of a user. The computing devices described herein have the advantage of being able to be mounted on the neck of a user by a variety of different wearable units, and therefore the head mounted device is not limited to only being used with a neck band.

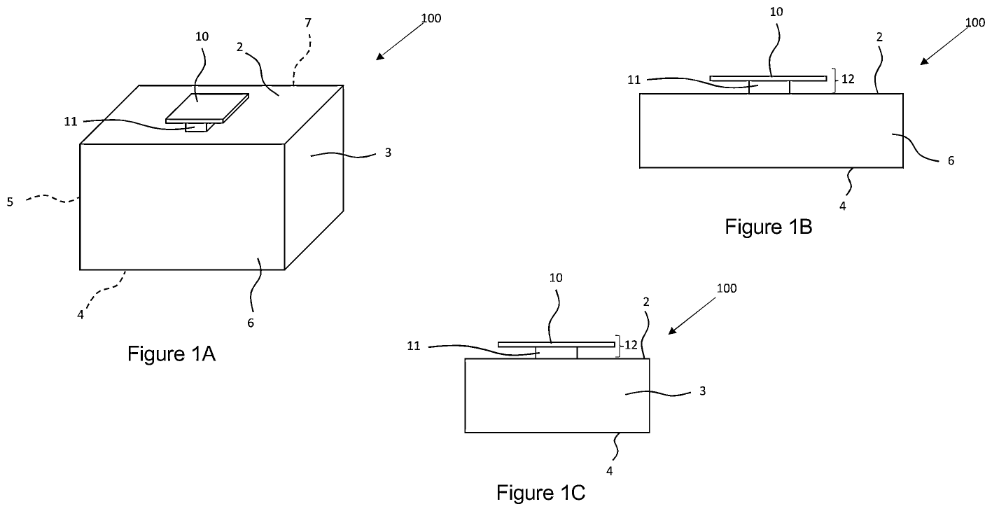

FIG. 1A shows a perspective view of an example of the computing device 100, according to an example. The computing device 100 comprises a housing, wherein in this example the housing is cuboidal. Therefore in this example the computing device is cuboidal. For example, FIG. 1B shows a first side view of the computing device 100, wherein the major side 6 is facing out of the page. FIG. 1C shows a second side view of the example of the computing device 100, wherein the minor side 3 is facing out of the page. The computing device 100 is cuboidal, having a top face 2 and a bottom face 4, opposing major sides 6, 7, and opposing minor sides 3, 5. The major sides 6, 7, are larger in area than the minor sides 3, 5. It will be appreciated that other sizes and shapes of device 100 may also be used in combination with the same features as described herein.

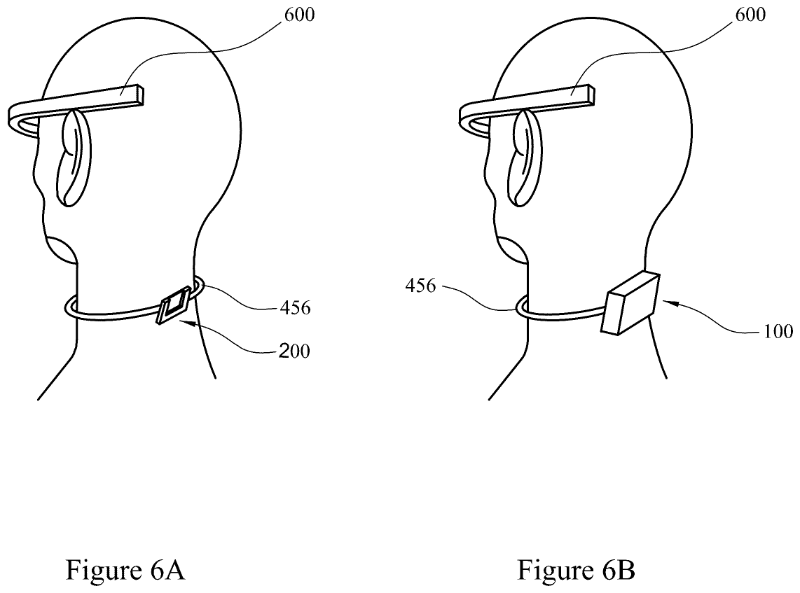

The housing of the computing device 100 is shaped such that when mounted at the back of user's neck, as will be described herein, the computing device occupies a volume that extends from the back of the user's neck away from the user's neck but that does not extend substantially around the side of the user's neck. This is shown in FIGS. 6A, 6B, 7A, 7B, 8A, 8B, and will be described in more detail in reference to those figures. Therefore, the housing, and the computing device can be any shape or size as long as it does not extend substantially around the side of the user's neck. For example, the computing device 100 may have a rectangular, or oval, or circular cross section. In other examples the computing device may have a cross section of any polygon shape such as a computing device with a triangle, parallelogram, rhombus, trapezoid, kite, pentagon, hexagon, heptagon, octagon, nonagon, decagon shaped cross section.

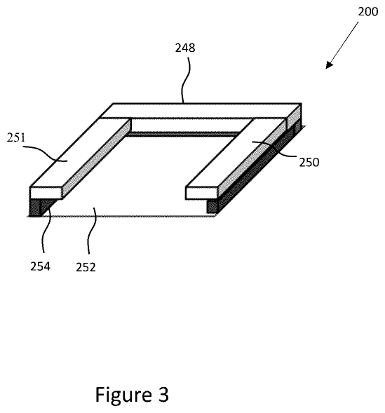

The computing device 100 of this example further comprises a connector 12 which is attached to the housing. The connector is configured to connect the housing to a mounting element, or mounting base, which provides a base or anchor point that is attachable to the user and to which the housing can be coupled as will be described herein. The connector 12 extends from a face of the housing, such as the top face 2, such that the face is not flat. The connector may extend from substantially the centre of the face 2, however it will be appreciated that the position of the connector may vary. The connector 12 in this example comprises a hook 10, wherein the hook is configured to be received by a corresponding mounting element, an example of which is illustrated in FIG. 3.

The connector 12 further comprises a leg 11, such that the hook is supported away from the housing via the leg 11. In the example shown, the hook has a rectangular surface. However it will be appreciated that the hook could have any suitable shape which enables it to be received by a corresponding portion on the mounting element. For example, the hook could be triangular in shape.

The leg 11 has a cross sectional area smaller than the area of the hook, such that there are at least two channels running adjacent the leg. Each channel runs in between the hook and the top face of the computing device 100. The channels are divided from one another by the leg. The leg may have a square cross section such that the length and width of the leg are both smaller than the length and width of the hook. Alternatively, the leg may have a rectangular cross section such that the length of the leg may be substantially the same length as the hook, but the width of the leg may be smaller than the width of the hook. It will be appreciated that in either shape of the leg, two channels are formed, where each channel is formed on either side of the leg 11. The leg may have a height of a few millimetres, for example 2 mm.

It will be appreciated that the connector may have a different shape. For example, the connector may instead be configured to receive a corresponding portion from a mounting element. For example, the mounting element may instead comprise an extending portion, such as a hook, and the connector may be configured to receive this hook. Therefore, as will be understood, the connector 10 may be any shape, such that it is configured to be connected to a mounting element. It will also be appreciated that in some embodiments it may not be necessary to have a connector and mounting element arrangement, and instead the wearable unit may comprise a portion which detachably connects with the connector 12 without requiring a mounting element.

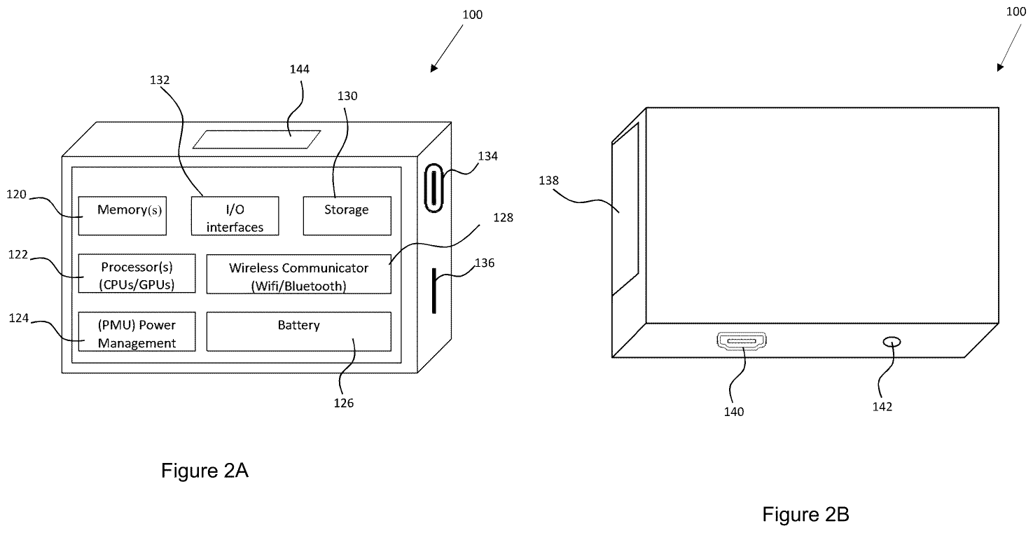

The computing device 100 comprises one or more processors 122 (CPUs/GPUs) mounted within the housing which are configured to process data received from a head mounted device which the computing device 100 is in connection and/or communication with. The computing device also comprises one or more memories 120 which are coupled to the one or more processors. The one or more memories may be coupled either directly or indirectly to the one or more processors. The computing device may also comprise one or more motherboards which are mounted within the housing. In the embodiment in which there is one motherboard, the one or more processors 122 and the one or more memories 120 are mounted to the motherboard. The motherboard may be any suitable shape. The housing of the computing device preferably has a similar, or the same, internal shape and size as the motherboard, such that the computing device is as compact as possible. An example computing device 100, which comprises a motherboard, is shown in FIG. 2A. FIG. 2A shows the internal components of the computing device. FIG. 2B shows an alternative view of the computing device, showing example data ports on the surface of the device.

As shown in FIG. 2A the computing device may comprise a memory 120, one or more processors 122, a power management unit (PMU), a power source, for example one or more batteries 126, a storage 130, one or more input-output (I/O) interfaces 132 and one or more wireless communicators 128 which may be configured to communicate via one or more of a wireless network (such as a 3G, 4G, or 5G network), a WIFI network, or via Bluetooth, or another form of wireless communication.

In the embodiments described herein there are no sensors located within the computing device 100. Instead, the sensors are located within the head mounted device, as will be described herein. However, it will be appreciated that in some other embodiments there may be some sensors located within the computing device 100. This would not affect the techniques and concepts described herein.

The housing may further comprise one or more input-output ports, i.e. interfaces, for sending and/or receiving data from the head mounted device. These ports will be described in relation to the example embodiment shown in FIGS. 2A and 2B.

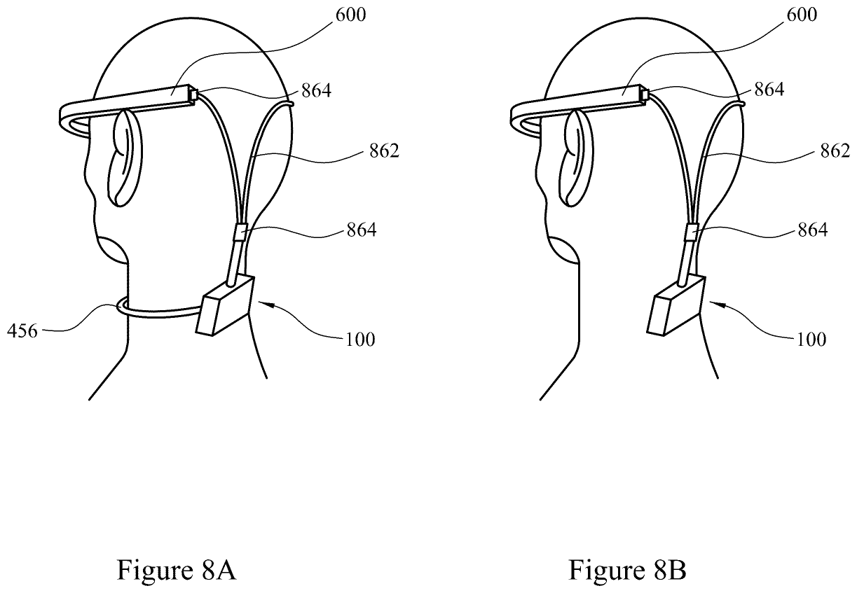

The housing may comprise a data line port 144. The data line may send and/or receive various data including one or more of audio data, video data, radar/LiDAR data, gyroscope/accelerometer data, LED data, and command data wherein the command data is input via buttons and/or touch sensors. As shown in FIG. 2A, it is preferable for the data line port, otherwise known as a data port or data line, to be positioned on a face of the housing which faces towards the top of the user's head in use. Therefore, the wires which connect the computing device 100 with a head mounted device, as will be described in relation to FIGS. 8A and 8B, can extend along the back of the user's head, taking the shortest and simplest path possible.

The housing may further comprise one or more of a USB port 134 (for example a micro-USB, mini-USB, or USB-C), a memory card slot 136 (for example a micro-SD slot), an HDMI or micro HDMI port 140, and an audio port 142 (otherwise known as an audio jack) which may be configured to allow wired headphones to be connected to the computing device 100. These ports are positioned around the sides of the housing. The housing may further comprise a battery slot 138, which enables one or more batteries to be removably inserted in the computing device. These one or more replaceable batteries may be in addition to the one or more batteries 126 mounted on the motherboard, or the one or more batteries 126 mounted on the motherboard may be replaceable via the battery slot 138.

It will be appreciated that FIGS. 2A and 2B are merely examples and that any combination of the components and input-output ports illustrated in FIGS. 2A and 2B may be present, without requiring all of the components or data ports as shown. For example, the computing device may not comprise one or more batteries mounted on the motherboard, and instead the computing device 100 may be powered by a remote power source, which is in electrical connection with, but separate to, the computing device. In such an example, it would be appreciated that there may be an additional port for connecting the external power source to the computing device 100. Alternatively, in such an embodiment, the external power source may be connected to the computing device via the USB port 134.

Furthermore, the position of the components and data ports on the motherboard and the housing is not limiting, and they can be positioned in any suitable arrangement without affecting the functioning of the computing device.

The computing device of the embodiments described herein may comprise a mounting element 200. The mounting element is configured to receive the connector 12, such that the housing can be connected to the mounting element 200 via the connector 12. In one example, illustrated in FIG. 3, the mounting element comprises a first surface, which is substantially flat. The mounting element 200 of this example also comprises channels along which a connector can slide. In particular, in this example, two side arms 250 and 251 form parallel channels. The two side arms are sufficiently spaced apart such that the leg 11 of the connector 12 can slide between the two side arms. The side arms are raised from the first surface 252 by a support 254, such that there is a channel between each of the side arms 250, 251 and the first surface 252. The channels do not extend to the outer edge of the mounting element, as the support 254 is positioned at the outer edge of the mounting element. Therefore the channels are closed at the outer edge of the mounting element. A further arm 248, positioned at a common end of the side arms, may be included. The side arms and end arm may be connected at right angles, such that the two side arms are parallel. The end arm 248 is also raised from the first surface such that there is a channel between the end arm and the first surface. Each of the channels are of equal height, wherein the channels have a height such that the mounting element is configured to receive a corresponding connector which is slid into the mounting element via the channels. The height of the channels may correspond to a thickness of the hook 10 as described in the example of FIGS. 1A, 1B and 1C. The hook 10 of the connector described in FIGS. 1A, 1B and 1C is configured to slide along the channel, until it reaches the end arm of the mounting portion. The portion of the hook which is configured to be slid into the mounting portion, i.e. a pair of opposing edges of the hook, may be considered to be rail portions. As the channels between each of the side and end arms are closed by one or more supports, the channels form a guide mechanism for guiding the connectors into the corresponding portion of the mounting element. Therefore the user can connect the computing device to the mounting element in use, i.e. when the mounting element is positioned on the user's neck behind the user's head and the user therefore cannot see the mounting element, as will be described in relation to FIGS. 6A, 6B, 7A, 7B, 8A and 8B.

The mounting element shown in FIG. 3 is only an example, and it will be understood that the mounting element could be any suitable design which enables a user to removably connect the computing device 100 with the mounting element. For example, the mounting element may not comprise an end arm, and instead may comprise another feature for enabling the user to determine when the connector has been fully inserted into the mounting element.

In another embodiment the connector may have a different shape, for example the connector may comprise a hook which is triangular in shape. In this embodiment the mounting element would comprise two arms, rather than three, which are connected to form a triangular configuration such that the mounting element is configured to receive the connector.

It should be noted that the connector and mounting element features may be reversed, such that the mounting element comprises one or more rail portions which are configured to be received by the connector. Therefore the mounting element and connector will connect by the mounting element sliding into the connector. It will be understood that the connector of this embodiment would therefore comprise arms and channels which are configured to receive the rail portions of the mounting element.

In the examples described above, the mounting element 200 and connector are slidably connected. However the connector and mounting element may be detachably connected in any suitable way.

As described above, the computing device is configured to be mounted on the back of the neck of the user. Therefore, the mounting element is configured to be mounted on a wearable unit, which enables the computing device to be mounted on the neck of a user. The wearable unit may be any suitable unit which enables the mounting element to be removably mounted on a user's neck.

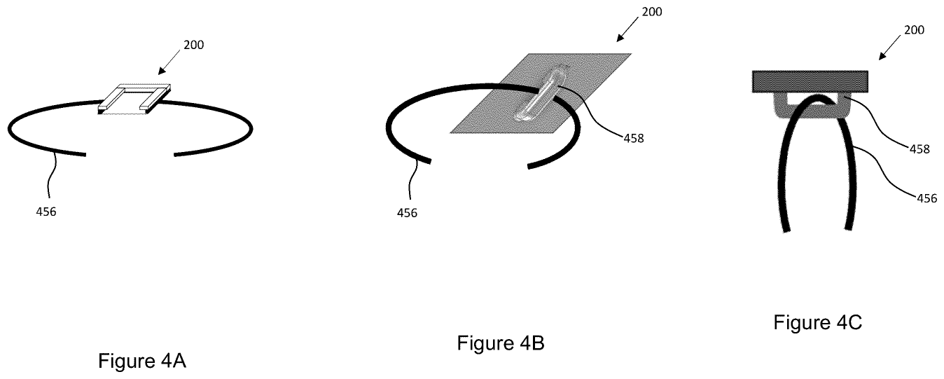

FIGS. 4A, 4B and 4C show a first example of the mounting element 200 being attached to a first example of a wearable unit. The wearable unit in this example is a neckband 456. The neckband may be flexible or rigid, and extends substantially around the neck as shown in the figures. The neckband is removably attached to the mounting element by a loop on, or hole in, the mounting element through which the neckband passes. FIGS. 4A, 4B and 4C, show an embodiment comprising a loop 458. The loop is positioned on the opposite side of the mounting element to the arms and guiding portion as described in relation to FIG. 3. The loop is positioned along the centre of the bottom face of the mounting element 200, being the face that abuts the user's neck during use. As shown in FIG. 4C, the central portion of the loop 458 is flat, such that the loop does not extend too far from the mounting portion, which therefore improves comfort. The loop 458 in use will lie against the user's neck, and therefore a loop as described improves the comfort and fit for the user.

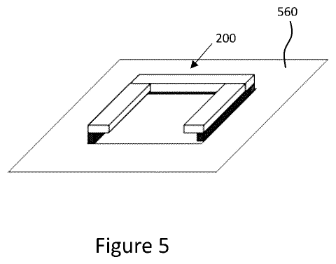

FIG. 5 shows a second example of the mounting element 200 being attached to a second example of a wearable unit. In this example the wearable unit is an adhesive patch 560 which has a greater area than the connector. The adhesive patch 560 is preferably a skin friendly flexible patch. The adhesive patch is secured to the bottom face of the mounting element 200. The adhesive patch is configured to stick to a user's skin, and is selected to be able to hold the weight of the computing device 100, whilst also being able to be removed when needed. The self adhesive patch may either be suitable for being used once, or may be reusable. The wearable unit may comprise reusable tape (for example reusable nano tape), or may comprise removable two-piece double sided stickers, such that the adhesive patch comes in two identical parts. For each part, one side may comprise non-reusable adhesive gel to be attached to the skin of a user or to the mounting element, and the other side may be based on a reusable locking-adhesive mechanism. The locking-adhesive mechanism of a first part can be attached to the locking-adhesive mechanism of the second part. The locking-adhesive mechanism can be plastic based. The user can replace the part attached to the user after each use, while the non-adhesive gel side of the second part is permanently attached to the mounting element.

By using an adhesive patch as the wearable unit, the computing device can be mounted to the skin, providing increased freedom of movement for the user. The self-adhesive patch may have any of the following features: made of non-woven fabric, breathable, sweat and water resistant, sticky non-irritating adhesive gel on one side of the patch.

Although the figures show the computing device being mounted to the back of the neck via either example of the wearable unit, it will be appreciated that in either examples, the computing device 100 can be positioned on another section of the user's neck, such as the side of the user's neck. In an example in which the computing device is mounted on a neckband, the computing device may be able to slide through the neckband between being mounted at the back of the neck, and being mounted at the side of a neck. The computing device being located at the side of the neck may improve comfort for situations where the head needs to be leaned back for resting or the back of the neck to be filled/touched by something (e.g. pillow).

FIGS. 6A and 6B illustrate an example of a system comprising a computing device as described herein. The system comprises a computing device 100 as described herein, and a head mounted device 600. In the system the head mounted device 600 and computing device 100 are physically separate, as shown in FIGS. 6A and 6B, but are communicatively connected to each other. The connection between the head mounted device and the computing device may be wired or wireless, and may include a power line. The head mounted device and computing device may be configured to communicate via one or more of a wireless network (such as a 3G, 4G, or 5G network), a WIFI network, or via Bluetooth, WIFI or another form of wireless communication. In other embodiments the head mounted device and computing device may communicate via a wired connection. The head mounted device 600 may also be powered by one or more batteries mounted within the computing device 100, as described in relation to FIG. 2A. However, it will be appreciated that the head mounted device 600 may be powered by an onboard power source of the head mounted device or a remote power source which is external to the computing device 100. Therefore, in some embodiments in which the head mounted device is powered by a power source remote from the computing device, and the head mounted device 600 and computing device 100 communicate wirelessly, there may be no electrical connection between the computing device 100 and head mounted device 600.

As described herein and shown in FIG. 6B, the computing device is shaped such that it extends away from the user's neck when positioned for use, for example it is a box which is not flat and has a thickness suitable for containing a processor of sufficient size, and the computing device does not extend substantially around the sides of the user's neck. As shown in FIGS. 6A and 6B, the computing device does not extend around the sides of the neck, and instead is shaped such that only the back of the neck is attached to the mounting element, and thus to the computing device 100. The computing device may be shaped such that the projection of the computing device, when viewed from directly in front or behind the user in use, does not extend beyond the projection of the user's neck. That is to say, the computing device, does not extend around the sides of the neck, so that the computing device cannot be seen from the front of the user in use.

The computing device may have a width of up to 120 mm, the width being the dimension of the computing device extending across the user's neck in use. The computing device may have a height of up to 80 mm, the height being the dimension of the computing device perpendicular to the width, the height extending up the user's neck from the base towards the head when in use. The computing device may have a depth of up to 50 mm. In other examples, the computing device may have a depth of up to 20 mm. It will be appreciated that the computing device may have any ratio of depth, width and height. In some examples the computing device may be circular, or a polygon. In some examples, the area of the surface of the computing device facing the neck may be smaller or larger than the area of the surface facing away from the neck. Therefore in one example the computing device may be a rectangular frustum.

As shown in FIGS. 6A and 6B, the computing device 100 may be mounted to the back of a user's neck using a neckband mounting as described in relation to FIGS. 4A, 4B and 4C. The neckband is connected to the computing device via a mounting element 200 as shown in FIG. 6A. The neckband extends around both sides of the user's neck, such that the computing device is removably attached to the user's neck. The computing device 100 slides onto the mounting element 200, as described herein, and as shown in FIG. 6B. The computing device may be connected to the mounting element 200 prior to the neckband being fitted to the user. Therefore, in some embodiments, the mounting element or connector may not comprise rail portions and channels to aid the user in fitting the computing device to the user's neck. Instead, other components could be used to fit the computing device to the neckband. In some examples, there may not be a connector portion and a mounting element. Instead, the housing itself could comprise a hole or loop for the neckband to pass through. Alternatively, the neckband could comprise an integral portion for connecting to the connector 12, without the need for a mounting element. Therefore, as will be appreciated by the skilled person, the computing device could be connected to the wearable unit in any suitable way.

The system further comprises a head mounted device 600, which is worn by a user. The head mounted device and the computing device 100 are physically separate, and are communicatively and optionally electrically connected to each other. The head mounted device comprises one or more sensors. The sensors may be used to sense environmental or user data. For example, the one or more sensors can be one or more of microphones, cameras, radar sensors, LiDAR, gyroscopes, accelerometers, button sensors or touch sensors. The head mounted device may be configured to send data to the one or more processors mounted within the computing device 100. The head mounted device may also comprise one or more output units for providing data to the user, and optionally to the surroundings. For example, each of the one or more output units may be any of one or more normal or transparent display screens, one or more directional air-conduction or bone-conduction speakers; one or more LEDs; one or more light projectors, or one or more laser projectors. For example, in response to data received by the one or more sensors, the head mounted device may control one or more LEDs to provide data to an external environment, for example to let other people know that a camera on the head mounted device is recording.

It will be appreciated that all of the essential components for the functioning of the system described herein, e.g. one or more processors and memory, are located within the computing device 100. There are no computing components located within the wearable unit, which will be described herein. For example, the wearable unit, e.g. neckband, does not comprise the one or more batteries 126, one or more processors 122, sensors, or a memory 120. Instead, the wearable unit is only required to mount the computing device on the wearable unit, and therefore the connection between the connector, the mounting element, and the wearable unit, as described herein, is only a mechanical connection rather than an electrical connection.

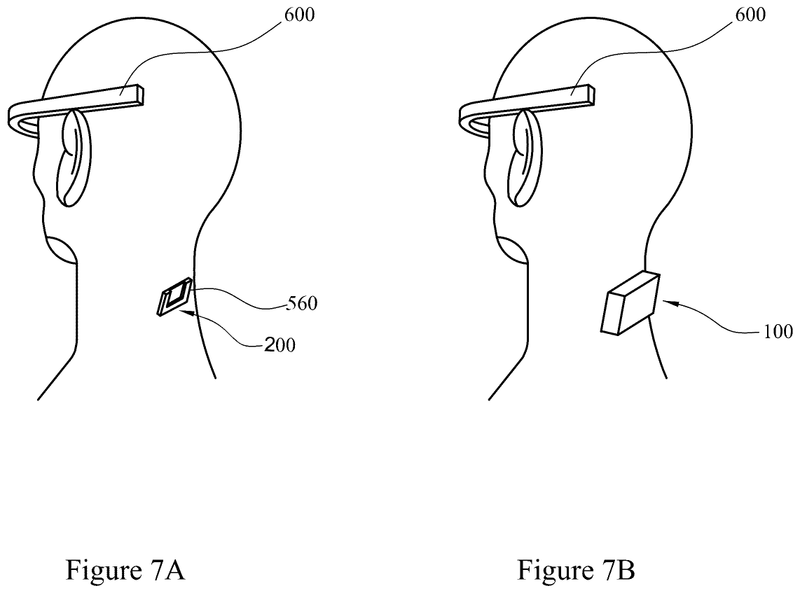

FIGS. 7A and 7B illustrate a second example of the system described in relation to FIGS. 6A and 6B. In this example the system also comprises the computing device 100 as described herein, and a head mounted device 600. In this system the head mounted device 600 and computing device 100 are also physically separate. The system may comprise any of the features described in relation to FIGS. 6A and 6B. In this second example, as illustrated, the computing device 100 is attached to the user's neck via an adhesive patch 560 as described in relation to FIG. 5. The computing device is shown as being attached to the back of the user's neck, however it will be appreciated that the computing device could be attached, via the adhesive, to any portion of the user's neck. The computing device 100 attaches to the neck by being first connected to a mounting element as described herein and shown in FIG. 7A. As described in relation to FIGS. 6A and 6B, the computing device has a size which results in the computing device not extending substantially around the side of the user's neck. The adhesive patch has a larger area in contact with the skin than the size of the connector and mounting element, such that there is a border of adhesive patch around the outside of mounting element as shown in FIGS. 5 and 7A.

As described herein, the computing device may be in electrical connection with the head mounted device. FIGS. 8A and 8B show an example illustrating the electrical connection between the computing device 100 and the head mounted device 600. FIG. 8A shows the connection in an example in which the computing device is mounted to the user's neck via a neckband 456. FIG. 8B shows an example wherein the computing device is mounted to the user's neck via an adhesive patch. In both examples, the computing device 100 is connected to the head mounted device by one or more wires or cables 862. In the illustrated example in FIGS. 8A and 8B, there are two wires 862, wherein a first wire is connected to the computing device 100 and a first side of the head mounted device 600, e.g. to a first arm of the head mounted device. The second wire is connected to the computing device 100 and a second side of the head mounted device 600, e.g. to a second arm of the head mounted device. As shown in FIGS. 8A and 8B, and as described herein, the computing device comprises a data port at its top face, i.e. the face of the computing device which faces towards the top of the user's head in use. The wires are connected to the computing device 100 via this data port, and therefore the wires are configured to pass to the head mounted device 600 via the back of the user's head. This ensures that the wires take the shortest path, where the path is not in the way of the user. This therefore provides maximum comfort and ease of use to the user, as well as reducing visibility of the computing device and wires.

In the example in which there are two wires, both of the wires are connected to the computing device 100, and diverge into two separate wires at a point around the top of the neck. The system further comprises one or more strain relief mechanisms 864 which are located between the head mounted device and the computing device. One strain relief mechanism may be located at each connection between the one or more wires and the head mounted device. Additionally or alternatively, one strain relief mechanism may be located at the point where the wires diverge around the top of the neck. In other words, the wires are separated into two segments by the lower strain relief mechanism. The upper segment is connected to the head mounted device 600 and the lower segment is connected to the computing device 100. When the two wires connect to the computing system 100 at the same port, they form a single cable. The wires diverge into two separate wires at the lower strain relief mechanism 864, such that the upper segment comprises two wires, each of which is connected to the respective arms of the head mounted device via a higher strain relief mechanism. Providing the lower and higher strain relief mechanisms in the system have the advantage that a user may remove the head mounted device 600, and the head mounted device 600 will hang against the user's chest without damaging the wire connections.

The head mounted device as described herein may be any head mounted device. Examples of head mounted devices are augmented reality headsets, virtual reality headsets, mixed reality headsets, smart glasses, augment reality glasses, hearing aids, or audio glasses. It will be appreciated that the techniques and concepts described herein may be applied to any such head mounted devices, to reduce the weight or size of the head mounted device, whilst improving processing power and/or battery life.

Various modifications to the example embodiments described above are possible and will occur to those skilled in the art without departing from the scope of the invention which is defined by the following claims. In particular, it should be understood that features described in relation to a single embodiment can be present in other embodiments.

1. A computing device for mounting on a neck of a user, comprising:
a housing;
one or more processors mounted within the housing, the one or more processors configured for electrical connection with a head mounted device and configured to process data received from the head mounted device;
one or more memories, mounted within the housing and coupled to the one or more processors;
wherein the housing is configured to mount to the back of the user's neck and is shaped to occupy a volume that extends from the back of the user's neck away from the user's neck but that does not extend around the sides of the user's neck.

2. A computing device according to claim 1 comprising a connector attached to the housing, wherein the connector is configured to connect the housing to a mounting element and wherein the mounting element is configured to releasably mount the device on a wearable unit.

3. A computing device according to claim 2, further comprising the mounting element, the computing device further comprising a guide mechanism for guiding the connector into a corresponding portion of the mounting element which is shaped to receive the connector, such that the user can mount the computing device to the mounting element in use.

4. A system according to claim 3 wherein the guide mechanism comprises one or more channels configured to receive corresponding rail portions, wherein the connector is connected to the mounting element by a sliding motion.

5. A system according to claim 4 wherein the one or more channels are provided on the mounting element and the rail portions are provided on the connector or vice versa.

6. A computing device according to any of claims 2 to 5 wherein the connector is a hook, and the mounting element is configured to receive the hook.

7. A computing device according to claim 6 wherein:
the hook is shaped to be received in the mounting element; and
the hook is supported away from the housing via a leg, wherein the leg has a smaller cross sectional area than the hook area.

8. A computing device according to any preceding claim wherein a motherboard is mounted to the housing, and wherein the one or more processors, and the one or more memories are mounted to the motherboard.

9. A computing device according to claim 8, wherein the housing is internally shaped to correspond to the shape of the motherboard.

10. A computing device according to any preceding claim wherein the housing is a rectangular box.

11. A computing device according to any preceding claim wherein the computing device further comprises a power source mounted within the housing.

12. A computing device according to any of claims 1 to 10 wherein the computing device further comprises a power source located remotely from the computing device.

13. A computing device according to any preceding claim wherein the housing comprises a data line port on a face which faces towards the top of the user's head in use.

14. A computing device according to any of claims 2 to 13 wherein the wearable unit is a neckband, and the mounting element comprises a hole or loop for the neckband to pass through such that the housing and mounting element are configured to be detachably mounted on a neckband.

15. A computing device according to any of claims 2 to 13 wherein the wearable unit is a self-adhesive patch for attaching to the skin, and the self-adhesive patch is attached to the mounting element, such that the device can be mounted on the skin.

16. A computing device according to claim 15 wherein the self-adhesive patch is flexible.

17. A computing device according to claim 15 or 16 wherein the self-adhesive patch has a greater area than the connector.

18. A system comprising the computing device according to any preceding claim, and a head mounted device, wherein the computing device and head mounted device are physically separate, and are electrically connected to each other.

19. A system according to claim 18 wherein the head mounted device comprises one or more sensors for sensing environmental and/or user data.

20. A system according to any of claim 18 or 19 wherein each of the one or more sensors may be any of microphones, cameras, radar sensors, LiDAR, gyroscopes, accelerometers, button sensors and/or touch sensors.

21. A system according to any of claims 18 to 20 wherein the head mounted device comprises one or more output units for providing data to the user, and optionally to the surroundings.

22. A system according to claim 21 wherein each of the one or more output units are any of:
one or more normal or transparent display screens;
one or more directional air-conduction or bone-conduction speakers;
one or more LEDs;
one or more light projectors; or
one or more laser projectors.

23. A system according to any of claims 18 to 22 wherein the computing device and head mounted device are connected by one or more wires.

24. A system according to claim 23 wherein the computing device and head mounted device are connected by two wires, wherein one wire is connected to the computing device and one side of the head mounted device, and one wire is connected to the computing device and the other side of the head mounted device.

25. A system according to claim 23 or 24 wherein the one or more wires pass from the computing device to the head mounted device via the back of the user's head.

26. A system according to any of claims 23 to 25 wherein the system comprises one or more strain relief mechanisms on the one or more wires.

27. A system according to claim 26 wherein the system comprises two wires and wherein a strain relief mechanism is located at one or both of:
an interface between the one or more wires and the head mounted device; and
between the head mounted device and the computing device.

28. A system according to any of claims 18 to 27 wherein the head mounted device is any of an augmented reality headset, virtual reality headset, mixed reality headset, smart glasses, augment reality glasses, hearing aids, audio glasses, or hearing aid glasses.
